(19) United States
(12) Patent Application Publication
(10) Pub. No.: US 2005/0241746 A1
(43) Pub. Date: Nov. 3, 2005

(54) Method for making a mat and resulting products

(75) Inventor: Michel Droux, La Ravoire (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: VETROTEX FRANCE, Chambery (FR)

(21) Appl. No.: 11/167,236

(22) Filed: Jun. 28, 2005

Related U.S. Application Data
(63) Continuation of application No. 09/774,177, filed on Feb. 2, 2001, now abandoned.

(30) Foreign Application Priority Data
Aug. 3, 1998 (FR) 98/09894

(51) Int. Cl. B32B 31/00

(52) U.S. Cl. 156/167; 156/176; 156/433

(57) ABSTRACT

The present invention relates to a process for manufacturing a mat whereby at least one first layer or series of layers of strand(s) formed of filaments and at least one second layer or series of layers of strand(s) formed of filaments are deposited on at least one moving conveyor, characterized in that at least some of the strand(s) of the first layer or series of layers are opened before the first layer or series of layers and the second layer or series of layers are superposed. The present invention also relates to a device for implementing the process and to the mats obtained.

The present invention relates to a process for manufacturing improved mats for producing, in particular, composite products and/or moulded products, particularly to a process for manufacturing improved mats made of continuous glass strands for producing composite products via injection-moulding techniques, and relates to a device that makes it possible to obtain such mats and to the mats obtained.

Products known by the name “mats” are essentially products used in the reinforcing industry and most often comprising glass strands formed of filaments. A distinction is generally drawn between two types of mats: chopped-strand mats and continuous-strand mats. Mats made of continuous strands of glass are products which are well known in the reinforcing industry and are generally used to produce composite products by moulding, particularly by compression moulding or injection moulding. They are usually obtained by the continuous distribution and superposition of layers of continuous strands on a conveyor, each layer being obtained from a bushing by drawing glass threads in the form of continuous filaments, then by combining the filaments into strands and projecting these strands onto the conveyor (with a swinging or to-and-fro movement so that the strands sweep right or partially across the width of the conveyor) moving transversely to the direction of the projected strands, the cohesion of the strands within the mat generally being afforded by a binder deposited on the strands then treated in an oven.

Rather different properties are looked for in the mats of continuous glass strands, depending on the envisaged applications; for example, when these mats are intended for the production of composites by pultrusion or are intended for electrical applications or for insulation, it is desirable to use flat mats consisting of strands which are strongly bound together and exhibiting only small gaps between the strands, and when these mats are intended for the production of composites by injection moulding, it is desirable to use sufficiently ventilated (or porous) mats, notably mats having or maintaining sufficient bulk (or being “inflated” enough) for a given weight of strand.

It is known practice for the surface finish of composites obtained from mats of continuous glass strands to be improved by coating these last with webs or veils of glass filaments held in place by a binder. Such an operation does, however, have drawbacks; aside from the fact that it may slow productivity and increase the cost of manufacture of the mats, it generally poses problems of compatibility or of securing of the webs and of the mats. To treat the mat in order to improve its surface finish may also lead to problems of a partial or complete loss of some of the properties of the mats (such as bulk, mechanical properties, etc.). At the present time there is no process that makes it possible, with good productivity, to obtain mats which are both sufficiently bulky and porous that they can be used satisfactorily in the manufacture of composites by injection-moulding techniques and at the same time allow the production of composites which have a particularly satisfactory surface finish.

The object of the present invention is to provide improved mats, particularly continuous-strand mats (preferably comprising glass strands) in particular allowing the production of composites and/or moulded products which have a particularly satisfactory surface finish and can be used satisfactorily in the manufacture of composites and/or moulded products using injection-moulding techniques, and is to provide an advantageous process for the production of these mats.

This objective is achieved by virtue of the process for manufacturing a mat according to the invention whereby at least one first layer or series of layers of strand(s) formed of filaments and at least one second layer or series of layers of strand(s) formed of filaments are deposited on at least one moving conveyor, characterized in that at least some of the strand(s) of the first layer or series of layers are opened before the first layer or series of layers and the second layer or series of layers are superposed.

As a preference, this is a continuous-strand mat, the aforementioned layers of strand(s) being layers of continuous strand(s).

The present invention also relates to a device for implementing the process, this device comprising at least:
a first device or series of devices for supplying a first layer or series of layers of strand(s) formed of filaments,
a second device or series of devices for supplying a second layer or series of layers of strand(s) formed of filaments,
at least one conveyor intended to receive the first layer or series of layers and the second layer or series of layers of strand(s),
and at least one device for opening strands which is located downstream of the first supplying device or series of supplying devices and upstream of the point of the conveyor at which the first layer or series of layers and the second layer or series of layers are superposed.

The present invention also relates to an improved strand mat, preferably a continuous-strand mat, this mat comprising one or more layer (layers) of integrated strand(s) (that is to say strands with integrity, the filaments being held together within the strands) and one or more layer (layers) of strand(s) at least partly opened in the form of filaments, this mat being obtained or being capable of being obtained according to the process of the invention. In particular, the present invention relates to a mat, preferably a continuous-strand mat, comprising one or more layer (layers) of integrated strand(s) and one or more layer (layers) of strand(s) at least partly opened in the form of filaments, the latter layer or layers having a filament dispersion gradient.

The process and the mats according to the invention exhibit numerous advantages over the conventional processes and mats, which advantages will be brought to light during the description which follows.

In the process according to the invention as defined earlier, a mat comprising several layers of strand(s) formed of filaments is formed by continuously depositing several layers of strand(s) formed of filaments onto at least one moving conveyor (the layers becoming superposed on one another) and by at least partially opening the strand(s) of one or more layers of strand(s) prior to superposition with one or more other layers of strand(s). More specifically, at least one first layer or series of layers of strand(s) formed of filaments and at least one second layer or series of layers of strand(s) formed of filaments are deposited on at least one moving conveyor (“first” and “second” not defining a chronological order in the present invention, but allowing the layers to be differentiated; the first layer may thus be deposited at a time after the second layer), the layers becoming superposed (in fact, each layer deposited on a conveyor becomes superposed with the layer or layers already deposited on this same conveyor) and, before the first layer or series of layers and the second layer or series of layers are superposed, at least some of the strand(s) of the first layer or series of layers are opened and their constituent filaments are at least partially dispersed.

It is very important in the present invention that the strands should be opened on some of the deposited layers prior to superposition with the other layers (and not, for example, on all of the layers deposited), as this allows numerous advantages to be obtained; in particular, in the case of the manufacture of a continuous-strand mat, this makes it possible to obtain both the desired surface finish and the desired bulk for the mat.

More generally, this procedure also makes it easier to obtain mats which have better cohesion throughout their thickness and require less binder to give them this cohesion, as will become clear later on in the description.

Each layer deposited on the conveyor contains one or more strand(s) and preferably comprises several strands (generally between one and a few tens of strands). Each strand used to form the mat comprises several filaments (for example of the order of 10 to 150 filaments), these filaments generally having a diameter from a few microns to a few tens of microns (for example, of the order of 5 to 24 microns in the case of glass filaments). If necessary, the filaments are initially held together within the strand by an appropriate sizing agent deposited (as is known) on the filaments at the time of manufacture of the strands (generally after the filaments are formed and before they are combined into strand(s)). The strands generally each have a linear mass ranging from 2 g/km to 100 g/km.

Each strand is formed, in most cases, of filaments made of a single material but may possibly be formed of a mixture of filaments of different materials (composite strand). The initial (i.e. prior to deposition on the conveyor and the opening-out of certain strands) characteristics (diameter, linear mass, etc.) or the construction of the strands used may differ from one layer to another whereas the strands within one same layer are generally similar and formed of the same material(s). The strands are preferably formed (of filaments) of one or more materials chosen from thermoplastics and/or reinforcing materials, for example chosen from organic thermoplastics such as polyethylene terephthalate or an acrylic polymer, and reinforcing materials such as glass. As a preference, the mats according to the invention are formed at least partially of reinforcing strands (that is to say strands containing filaments made of one reinforcing material at least), advantageously glass strands, these strands being formed of glass filaments only (the most frequent scenario) or possibly being formed of glass filaments mixed with filaments made of an organic material (composite strands). As a particular preference, the strands forming the mats according to the invention are essentially (to the extent of more than 20% by weight, preferably more than 50% by weight of the strands) or solely, made of glass strands and/or the mats comprise, as layer (layers) of integrated strand(s), one (or more) layer (layers) of glass strand(s) and, as layer (layers) of open strand(s), one (or more) layer (layers) of strand(s) made of an organic thermoplastic (such as polyethylene terephthalate or an acrylic polymer, for example).

The glass strands used, as appropriate, to form the mat according to the invention are generally E glass strands, these strands being the strands most commonly used in the field of reinforcements. Other types of glass strand may also be used to form the mat, such as A glass strands, particularly for forming the first layer or series of layers (layer (layers) of open strand(s) according to the invention). As a preference, the second layer or series of layers of strand(s) (layer (layers) of integrated strand(s)) is formed of E glass strand(s), and in most instances according to the invention, the mat comprises, by way of strands, only E glass strands.

As a preference, the process according to the invention is a direct process in which filaments are formed from feed devices, such as, for example, bushings and/or extrusion devices, then the filaments are grouped together into strand(s) which are distributed using projecting devices onto at least one moving conveyor so as to form the layers of strand(s) according to the invention, each collection of strand(s) projected from a projecting device forming one layer of strand(s).

For example, according to one preferred embodiment of the invention, the strand or strands of each layer of the mat are obtained from at least one bushing (or die) by drawing a great many threads of molten glass, flowing from a great many orifices at the base of the bushing in the form of one or several fans of continuous filaments and then by combining the filaments into the form of the strand or strands. In this embodiment of the invention, the drawing and pulling of the strands of each layer is achieved using a drawing system or “drawing wheel” rotating about a fixed axis and equipped with a projecting member or “bladed wheel” swung back and forth with respect to this axis, this projecting member projecting and distributing the strands onto the conveyor moving transversely with respect to the direction of the projected strands.

In one embodiment of the invention the strand or strands of at least one layer may also be obtained by extruding and pulling a thermoplastic organic material at the same time as the glass threads are drawn in the form of filaments, the paths followed by the glass filaments and the thermoplastic organic filaments converging together before the said filaments are combined into one or more composite strands which are pulled by the drawing system mentioned earlier. This embodiment of the invention makes it possible to obtain a mat which has at least one layer of composite strands.

In another advantageous embodiment, the strand or strands of the second layer or series of layers of the mat are obtained from bushing(s) like the one described previously and the strand or strands of the first layer(s) of the mat are obtained by extruding and pulling from extrusion device(s), a thermoplastic organic material in the form of filaments which are grouped together into the said strand or strands.

As a preference, according to the invention, particularly when the feed devices all have very similar or identical outputs, the first layer or series of layers comes from one to four feed devices, for example from one to four bushings or from one to four extrusion devices, the second layer or series of layers generally coming from a far greater number of feed devices (for example so that the first layer or series of layers form merely of the order of 5 to 20% by weight of the mat obtained, this mat thus simultaneously having a good surface finish, good mechanical properties and the desired bulk in the case of continuous strands).

According to the invention, the strands are generally opened by one or more mechanical (or partially, mechanical) means acting on the strands of the first layer or series of layers deposited on the conveyor. As a preference, the strands are opened mechanically under the action of a cascade and/or of jets of fluid (for example a cascade or jets of water or a cascade or jets of liquid binder as mentioned later) arriving transversely on the strand(s) of the first layer or series of layers arranged on the conveyor. The strands, in the case of continuous strands, are preferably opened under the action of a cascade of liquid poured out onto the strand(s) of the first layer or series of layers deposited on the conveyor, whereas the use of jets is preferred in the case of chopped strands.

According to the invention, the strand or strands of the first layer or series of layers are opened, at least partially, that is to say that the filaments making up the strand(s) or the filaments of at least some of the strands are detached over one or more portions of the strand(s) and occupy (or spread out on) an area (or cross section) which is larger than the one initially occupied by the strand (for example a cross section of the order of a few millimetres whereas the strand initially has a cross section smaller than 1 millimetre), these filaments usually still remaining contiguous (or the strand retaining approximately its initial cross section) at other points along the strand(s).

Depending on the type of opening device employed, this device may also disperse the filaments to a greater or lesser extent. In the embodiment of the invention employing a cascade or jets of liquid, this cascade or these jets may thus be regulated (for example as far as their flow rate is concerned) so as to allow the strand(s) to be opened and at the same time encourage their constituent filaments to disperse. For example, and particularly in the case of continuous strands, the use of a cascade with a flow rate of the order of 1 to a few cubic metres per hour per metre width of cascade, for a conveyor travelling at speeds of the order of a few metres to a few tens of metres per minute, allows for good opening of the strands and good dispersion of the filaments. It is also possible to envisage the use of an additional dispersing device separate from the strand-opening device or devices; for example, the strand or strands of the first layer or series of layers may, while they are being opened or afterwards, pass through a bath that encourages their constituent filaments to disperse. This bath may, for example, consist of the excess liquid falling from the cascade or from the jets and not retained by the layers of strand(s) or may be independent of the cascade or of the jets. It may be contained on a portion of the conveyor (particularly in instances where this conveyor is in the form of a non-impervious web of fabric), particularly downstream of the opening device or devices, by means of a plate placed under the conveyor and, possibly, by means of side walls bordering the conveyor. The presence of the bottom plate containing the bath may, if appropriate, allow for better opening of the strands and dispersion of the filaments.

The layer or first series of layers obtained after the opening of the strand(s) and the dispersing of the filaments, generally has or have a filament dispersion gradient, the action of the opening devices of the cascade or jets type being exerted mainly at the surface of the layer or layers receiving the cascade or the jets and then being exerted to ever lesser extents right as far as the opposite surface, generally the surface in contact with the conveyor, of the layer or layers. In other words, dispersion of the filaments constituting the strand(s) of the first layer or series of layers decreases (the filaments spread out over an area of smaller and smaller size and/or the strands are opened over an increasingly diminishing length compared with the total length of strand) the more distant they are from the face (of the layer or layers) which received the cascade or the jets.

According to the invention, the strand or strands of the first layer or series of layers are opened while they are on a conveyor and then are superposed with the strand(s) of the second layer or series of layers, that is to say that they may come and cover the strand(s) of the second layer or series of layers or they may be covered by the strand(s) of the second layer or series of layers (as a general rule, and as a preference, they are covered by the strand(s) of the second layer or series of layers and are in contact with the conveyor).

The strands of the various layers may be deposited successively on the same conveyor or may be deposited on several conveyors, final superposition of all of the layers taking place on a conveyor on which all the layers arrive (and are therefore deposited) (it being possible for some layers to come from other conveyors on which they were initially deposited). In particular, the strand or strands of the first layer or series of layers may be opened on a first conveyor, then may be introduced onto a second conveyor before covering or being covered by the strand(s) of the second layer or series of layers, on this second conveyor. This embodiment in particular has the advantage of allowing the use, for each layer or series of layers, of conveyors suited to the treatments that are experienced by these layers.

According to one advantageous embodiment of the present invention, the strand or strands of the first layer or series of layers are positioned or re-positioned on the conveyor before covering or being covered by the strand(s) of the second layer or series of layers so that the greatest dispersion of filaments is on an outer face of the fibrous structure (or mat) thus formed. For example, the strand(s) of the first layer or series of layers are deposited and then opened by a cascade or jets of fluid on a first conveyor and then cover the strand(s) of the second layer or series of layers on a second conveyor in such a way that the most open strand(s) is (are) on the top face of the fibrous structure obtained, or alternatively the strand or strands of the first layer or series of layers are deposited and then opened by a cascade or jets of fluid on a first conveyor and are then introduced onto a second conveyor turning the layer or series of layers over so that the strands on the top face of the layer or series of layers are on the bottom face and vice versa before the layer or series of layers is or are covered with the strand(s) of the second layer or series of layers in such a way that the most open strand(s) is (are) on the bottom face of the fibrous structure obtained. These embodiments make it possible to further improve the surface finish (at least on one face) of the products obtained.

As a preference, in the process according to the invention, provision is also made for coating the layers of strands with at least one binder which, after an appropriate treatment, for example after melting and/or polymerization and/or cross-linking thereof, provides for the cohesion of the strands and filaments of which the mat is made. As a preference, use is made of at least one binder in the form of a liquid and as a particular preference, use is also made of at least one binder in powder form in addition to the liquid binder, these two binders or these two parts of binder advantageously being deposited separately.

The liquid binder is preferably deposited (poured, sprayed) onto the first layer or series of layers of strands after the strands have been opened and/or their constituent filaments dispersed, or at the same time as the opening and/or dispersion, and prior to superposition with the second layer or series of layers, and allows the strands of the first layer or series of layers to be pre-bound. In the embodiment of the invention employing a cascade or jets of liquid as a device for opening the strands, this binder preferably corresponds to the liquid poured out by the cascade or the jets of liquid (or is present in this liquid). The binder in powder form is preferably poured onto the second layer or series of layers after the various layers have been superposed. The layer or layers pre-bound by the liquid binder are preferably placed on the bottom face of the mat formed on the conveyor in order to minimize the effect of any insufficiency of powder binder reaching the first layer or series of layers or to hold the powder binder in the mat and thus allow this mat to be bound over its entire thickness using minimal quantities of liquid binder and powder binder. The use of small quantities of binder, particularly of powder, also makes it possible to avoid the formation of accumulations of binder or of powder which may detract from the surface finish of the product obtained. The mat thus obtained is sufficiently bound without there being an excessive or large amount of binder, throughout its thickness and on both faces, thereby making a saving on binder.

The combined use of a liquid binder and of a binder in powder form, as described earlier, in the process according to the invention thus has a number of advantages: in particular it makes it possible to obtain a particularly uniform distribution of binder within the mat, particularly throughout its thickness, using small amounts of binder, unlike the use of a binder solely in the form of powder, possibly dispersed in a non-sticking liquid, or solely in the form of a solution, these latter types of binder actually spreading themselves more selectively through the mat and being used in greater quantity in order to obtain bonding throughout the thickness of the mat, this leading to strands being excessively bound at certain points in the mat.

The binder (or the part of the binder) in liquid form is in the form of a solution or emulsion or suspension and generally comprises a solvent or (in the case of an emulsion or a suspension) a medium or vehicle, for example water, a bonding agent in the form of polymer(s), for example a polyvinyl acetate or an acrylic or polyester resin, a coupling agent, for example a silane, and a dispersing agent, for example a non-ionic or cationic surfactant. The binder (or the part of the binder) in powder form is generally in the form of thermoplastic or thermoset polymer(s), for example in the form of unsaturated polyester(s).

The “dry” content of the liquid binder (that is to say what remains after the solvent or medium has been evaporated off) that it is intended to deposit, as appropriate, on the first layer or series of layers preferably represents from 0 to 5% by weight of the weight of the first layer or series of layers (the dry extract of the liquid binder representing, for example, of the order of 3 to 12% of the liquid binder), and the content of binder in powder form deposited, as appropriate, on the second layer or series of layers preferably represents from 2 to 6% by weight of the overall weight of the layers deposited.

The binder, particularly the binder in liquid form, not retained by the mat may be recycled and re-used in the process according to the invention, its composition being re-adjusted by topping-up with liquid or solid prior to deposition on further strands or further portions of strands in the process according to the invention.

The fibrous structure obtained after the deposition of the second layer or series of layers and after the deposition of the binder for binding the layers together, is generally introduced into a device which allows or encourages melting and/or polymerization and/or cross-linking of the binder, for example a heat treatment device such as an oven or, for example, depending on the choice of binder, an irradiation device such as a source of ultraviolet radiation. If appropriate, the sheet of strands obtained after the deposition of the second layer or series of layers may have been treated to remove the excess water from the strands, for example may have been dried by passing through a first oven before the deposition, as appropriate, of the binder in powder form and before, for example, passage into a second oven for melting and/or polymerizing and/or cross-linking the binder. This drying makes it possible, as necessary, to fix the active components of the liquid binder deposited and/or allows the binder in powder form to better make its way into the layers of strands. It is also possible to spray a fluid such as water onto the sheet of strands (that is to say to re-humidify the strands slightly) just before and/or just after the deposition of binder in powder form so as to better fix this binder on the strands.

The mat according to the invention generally has an overall mass per unit area of at least 150 g/m². It generally comprises (or consists of) one or more layers (corresponding approximately to the second layer or series of layers) with a mass per unit area of at least 120 g/m² (and preferably at least 170 g/m², it being possible for this mass per unit area to extend as high as 900 or even 1800 g/m²) and one or more layers (corresponding approximately to the first layer or series of layers) with a mass per unit area of at least 20-30 g/m² (and preferably at least 70 g/m²), this mass generally being lower than that of the other aforementioned layer (layers) and, in most cases, being below 150 g/m².

The mat according to the invention most usually consists of a fibrous structure, generally coated with a binder treated as described earlier, this structure being obtained according to the process of the invention. This mat (or this fibrous structure) comprises at least one layer of glass strand(s) opened at least partially in the form of filaments and having a filament dispersion gradient (or alternatively an area-occupied-by-open-strands gradient) and at least one layer of integrated (or intact) glass strand(s), that is to say of strand(s) made up of filaments which are secured together, this (these) strand(s) generally having an approximately round cross section, this last layer being bound to the other layer or layers by a binder or binders and having retained (particularly when it is a layer of continuous strands) its initial bulk and good porosity because it has not experienced the compression or breaking-up force during the process. The presence of this last layer also makes it possible to obtain composites which have good mechanical properties. In general, the layer (layers) of open strand(s) represent(s) from 5 to 50% by weight of the fibrous structure obtained according to the invention (or of the mat) and preferably represent(s) from 5 to 20% (or even, in most cases, from 8 to 20%) of this structure (or of the mat).

The mat according to the invention may also possibly be formed by assembling back to back two fibrous structures obtained according to the process of the invention and by binding them, for example by sticking, so that they have one or more central layer (layers) formed of integrated glass strand(s) and external layers each having a filament dispersion gradient, such a mat having the advantage of having a good surface finish on both faces.

The mats according to the invention have, in the case of continuous strand mats, satisfactory bulk compared with their weight of strands so that they can be used in injection moulding. For example, for a grammage (or mass per unit area) of the order of 450 g/m², they have a thickness (under a pressure of less than 50 g/cm²) of at least 1.5 mm, generally at least 2 mm (unlike the mats intended, for example, for electrical applications or for pultrusion which, for the same grammage, have a thickness of less than 1 mm). Continuous strand mats according to the invention make it possible easily and effectively to obtain composites and/or moulded products, particularly injection-moulded products which, in particular, have a particularly satisfactory surface finish. The composites obtained comprise at least one mat according to the invention and at least one organic and/or inorganic material, preferably at least one organic thermoplastic or thermoset or elastomer material (such as a polyurethane).

Although the process and the mats according to the invention have been described as a preference in the case of continuous strand mats, the process and the mats according to the invention are also particularly advantageous in the case of chopped strand mats which case is also covered by the present invention. Chopped strand mats may be obtained by proceeding as described above in the case of continuous strands, the strands obtained by grouping filaments together, however, being chopped by a chopping device before they are deposited or at the same time as being deposited in the form of a layer or layers on the conveyor in the process according to the invention, these strands coming directly from bushings and/or extruders, or possibly also coming from windings. The mats obtained also have two types of layer (layers) as defined according to the invention, the advantages obtained being, in particular, better cohesion within the thickness of the mat, a saving of binder (less binder needed for cohesion and, as appropriate, lower losses of binder because the open strands better retain the binder within the bottom part of the mat) and a better surface finish. The mats according to the invention may also combine both continuous strands and chopped strands, and the layers of strands used in the process according to the invention may, in the case of some of them, be continuous strand layers and, in the case of others, be chopped strand layers.

Other advantages and features of the invention will become apparent in the following description with reference to the drawings illustrating advantageous embodiments of the present invention, these embodiments being illustrative but non-limiting.

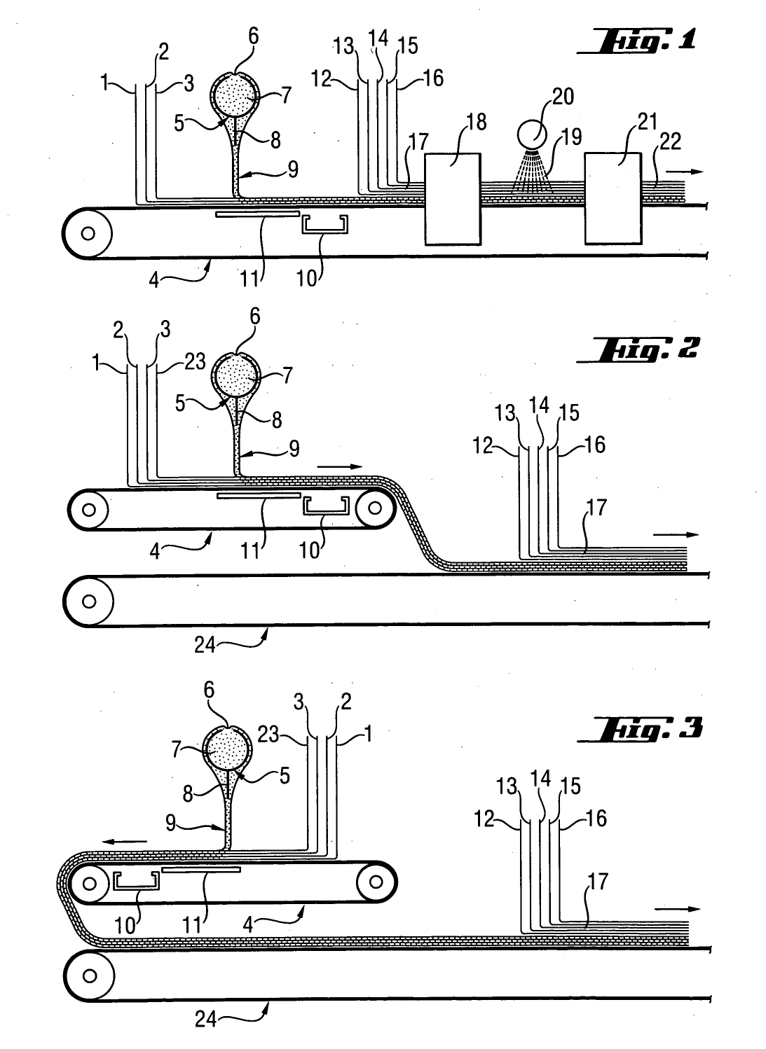

FIG. 1 diagrammatically depicts a first embodiment of the invention.

FIG. 2 diagrammatically depicts a second embodiment of the invention.

FIG. 3 diagrammatically depicts a third embodiment of the invention.

In the depicted figures, the direction of travel of each conveyor is marked by an arrow over the conveyor.

In the embodiment illustrated in FIG. 1, a first series of layers (1, 2, 3) of strands, coming from three bushings or three extruders (not depicted), each layer comprising one or more strands and covering the strand(s) of the previous layer, is continuously deposited on a moving conveyor (4). The material of which the belt of the conveyor is made may, for example, be steel wire fabric. The first series of layers passes under a strand-opening device (5), this device (for example in the form of a hollow cylinder with a vertical wall at its base) having an opening (6) at its top to allow the continuous escape of a liquid binder (7) fed continuously to the device, this liquid binder flowing along a partially bottom vertical wall (8) of the opening device and thus falling in the form of a screen (or cascade) of liquid (9) onto the first series of layers. The flow rate of liquid binder is chosen to be such as to allow the strands to be opened and to allow the desired dispersion of strands, the binder at the same time allowing the strands of the first series of layers to be bound together.

The excess binder deposited on the mat and not retained thereby may be temporarily held at the surface of the conveyor so as to form a bath in which the first series of layers runs and so as to allow better dispersion of the filaments forming the strands after these strands have been opened. A leakproof rigid plate (11) and possibly side walls (not depicted in the figures) may be used for this purpose to retain the excess liquid binder over a certain portion of the path of the layers of strands, then the excess binder is removed, for example through the conveyor and possibly recovered and then recycled using (an) appropriate device(s) (depicted diagrammatically as 10). If necessary, the composition of the binder is re-adjusted before it is re-introduced into the device (5).

After the strands have been opened and their constituent filaments dispersed, the first series of layers of strands is continuously covered with a second series of layers of strands (five layers 12, 13, 14, 15, 16 being depicted here for practical reasons, but the number of layers in the second series generally being higher) from bushings (not depicted). The sheet or fibrous structure formed (17) is possibly dried in an oven (18) and then coated with binder (19) in powder form using one or more appropriate device(s) (20), this sheet possibly being re-humidified slightly before and/or after the deposition of the powder so as to allow better fixing thereof. The binder (liquid and in powder form) is then treated, for example in an oven (21), so as to obtain a mat (22), it being possible for this mat then to be collected and/or cut and/or assembled with other similar mats (these operations are not depicted) so as to obtain the end mat(s). It may be possible to provide a device (not depicted) for cleaning or washing the belt of the conveyor (generally an endless belt) so as to remove any binder that may have become stuck to the conveyor, as the belt returns towards the initial stages of the process. It is also possible to use several conveyors in succession instead of just one conveyor (4).

In the embodiment depicted in FIG. 2, a first series of layers (1, 2, 3, 23) of strands, coming from four bushings or four extruders (not depicted), each layer comprising one or more strands and covering the strand(s) of the previous layer, is continuously deposited on a first moving conveyor (4). The first series of layers passes under a strand-opening device (5) pouring a liquid binder out in the form of a cascade onto the first series of layers.

Like in the first embodiment, the first series of layers runs through a bath formed of the excess binder, so as to allow better dispersion of the filaments that make up the strands after these have been opened, this bath being delimited by a plate (11) and possibly walls (not depicted), then the excess binder is removed and possibly recycled using (an) appropriate device(s) (10), like in the first embodiment.

After the strands have been opened and their constituent filaments dispersed, the first series of layers of strands is transferred onto a second conveyor (24) where it is continuously covered with a second series of layers of strands (12, 13, 14, 15, 16). The sheet (17) formed is then treated as in the embodiment illustrated in FIG. 1.

The embodiment depicted in FIG. 3 is similar to the embodiment depicted in FIG. 2 except that the first series of layers of strands is “turned over” before it is introduced onto the second conveyor. Thus, the strands which, on the first conveyor (4), were on the top face of the first series of layers find themselves on the bottom face on the second conveyor (24) and the strands which, on the first conveyor (4), were on the bottom face find themselves on the top face on the second conveyor (24). The most “open” strands which give a better surface finish are therefore on one surface of the formed mat.

Mats obtained according to the invention may be used to advantage in the production of various composite items, particularly in the manufacture of injection-moulded items (for example car parts such as lorry cabs, etc.) or pressings, etc.

1. Process for manufacturing a mat whereby at least one first layer or series of layers of strand(s) formed of filaments and at least one second layer or series of layers of strand(s) formed of filaments are deposited on at least one moving conveyor, characterized in that at least some of the strand(s) of the first layer or series of layers are opened before the first layer or series of layers and the second layer or series of layers are superposed.

2. Process according to claim 1, whereby the strands are continuous strands.

3. Process according to claim 1, whereby the strands are, at least in the case of some of them, chopped strands.

4. Process according to claim 1, whereby the strands are formed of reinforcing filaments, preferably glass filaments, and/or filaments made of an organic material.

5. Process according to claim 1, characterized in that the strands are opened mechanically under the action of a cascade and/or of jets of fluid arriving transversely on the strand(s) of the first layer or series of layers on the conveyor.

6. Process according to claim 1, characterized in that the strand or strands of the first layer or series of layers, during or after opening, pass through a bath which encourages their constituent filaments to disperse.

7. Process according to claim 1, characterized in that the strand or strands of the first layer or series of layers are opened by a fluid comprising a liquid binder.

8. Process according to claim 1, characterized in that a binder in powder form is poured onto the superposed layers of strands(s).

9. Process according to claim 8, characterized in that the strands are re-humidified just before and/or just after the powder-form binder is deposited.

10. Process according to claim 7, characterized in that the superposed layers of strand(s) are introduced into a device for melting and/or polymerizing and/or cross-linking the binder.

11. Process according to claim 10, characterized in that the superposed layers of strand(s) are dried before being introduced into a device for melting and/or polymerizing and/or cross-linking the binder.

12. Process according to claim 1, characterized in that the strand or strands of the first layer or series of layers are opened on a first conveyor then introduced onto a second conveyor on which they are covered with the strand(s) of the second layer or series of layers.

13. Process according to claim 1, characterized in that the strand or strands of the first layer or series of layers are turned before being introduced onto the second conveyor.

14. Process according to claim 1, characterized in that each layer of strand(s) comes form a bushing and/or extruder and/or from (a) winding(s).

15. Device for implementing the process, this device comprising:
a first device or series of devices for supplying a first layer or series of layers of strand(s) formed of filaments,
a second device or series of devices for supplying a second layer or series of layers of strand(s) formed of filaments,
at least one conveyor intended to receive the first layer or series of layers and the second layer or series of layers,
and at least one device for opening strands which is located downstream of the first supplying device or series of supplying devices and upstream of the point of the conveyor at which the first layer or series of layers and the second layer or series of layers are superposed.

16. Device according to claim 15, characterized in that the device for opening the strands has an opening at its top allowing the continuous escape of a fluid supplied continuously to the device, this fluid flowing along a vertical wall at the base of the opening device.

17-21. (canceled)
